(19) United States
(12) Patent Application Publication
(10) Pub. No.: US 2021/0142413 A1
(43) Pub. Date: May 13, 2021

(54) HYBRID AUTOMATED INVESTMENT SELECTION SYSTEM

(71) Applicant: Wells Fargo Bank, N.A., San Francisco, CA (US)

(72) Inventors: Joseph C. Curatola, South Milwaukee, WI (US); Christopher Estell, Kenosha, WI (US); Daniel Johnson, Milwaukee, WI (US); Travis Keshemberg, San Francisco, CA (US); Tanya M. Schulz, Germantown, WI (US)

(21) Appl. No.: 15/462,041

(22) Filed: Mar. 17, 2017

(51) Int. Cl. G06Q 40/06

(52) U.S. Cl. CPC G06Q 40/06

(57) ABSTRACT

One embodiment relates to a financial institution computing system including an advising rules database configured to store a plurality of advising programs, a network interface, and an analysis circuit. The analysis circuit is configured to select a first advising program for the customer, receive information concerning the customer, and to select a second advising program from the advising rules database for the customer based on the received information concerning the customer.

### BACKGROUND

Financial institutions provide financial advice to a variety of customers. Generally, however, due to costs associated with providing personalized financial advice from a financial adviser, only a small set of customers that require or would benefit from personalized financial advice typically receive personalized of financial advice.

### SUMMARY

One embodiment relates to a financial institution computing system. The financial institution computing system includes an advising rules database configured to store a plurality of advising programs, wherein each advising program includes at least one automated advising rule and/or at least one personal advising rule, wherein each automated advising rule is associated with at least one event of a first event type associated with at least one investment action, wherein each personal advising rule is associated with at least one event of a second event type and is associated with receiving input from an advisor of a financial institution. The financial institution computing system also includes an account database configured to store customer information concerning a plurality of financial accounts at the financial institution. The financial institution computing system also includes a network interface configured to communicate data with at least one of a customer computing device associated with a customer, a plurality of merchant computing devices, and a plurality of third party computing devices over a network. The financial institution computing system also includes an analysis circuit, the analysis circuit communicatively coupled to the customer database, the customer activity database, and the network interface. The analysis circuit is configured to select a first advising program for the customer from the advising rules database. The analysis circuit is also configured to receive information, over the network via the network interface, concerning the customer from at least one of the following: the customer computing device, one of the plurality of merchant computing devices, and one of the plurality of third party communication devices. The analysis is also configured to select a second advising program from the advising rules database for the customer based on the received information concerning the customer, wherein the second advising program contains a different set of personal advising rules than the first advising program.

Another embodiment relates to a method. The method includes selecting, by a financial institution computing system, a first advising program for a customer, the first advising program selected from a plurality of advising programs stored in an advising rules database associated with the financial institution computing system, wherein each advising program in the plurality of advising programs includes at least one automated advising rule and/or at least one personal advising rule, wherein each automated advising rule identifies at least one event of a first event type and is associated with at least one investment action, wherein each personal advising rule identifies at least one event of a second event type and is associated with receiving input from an advisor of a financial institution associated with the financial institution computing system. The method also includes receiving, by the financial institution computing system, information concerning the customer from at least one of the following: a customer computing device associated with the customer, at least one merchant computing device, and at least one third party communication device. The method also includes selecting, by the financial institution computing system, a second advising program from the advising rules database for the customer based on the received information concerning the customer, wherein the second advising program contains a different set of personal advising rules than the first advising program.

Another embodiment relates to a non-transitory computer readable media having computer-executable instructions embodied therein that, when executed by an analysis circuit of a financial institution computing system, causes the financial institution computing system to perform operations to implement an investment strategy of a customer. The operations include selecting a first advising program for the customer, the first advising program selected from a plurality of advising programs stored in an advising rules database associated with the financial institution computing system, wherein each advising program in the plurality of advising programs includes at least one automated advising rule and/or at least one personal advising rule, wherein each automated advising rule identifies at least one event of a first event type associated with at least one investment action, wherein each personal advising rule identifies at least one event of a second event type and associated with receiving input from a human advisor of a financial institution associated with the financial institution computing system. The operations also include receiving information concerning the customer from at least one of the following: a customer computing device associated with the customer, at least one merchant computing device, and at least one third party communication device. The operations also include selecting a second advising program from the advising rules database for the customer based on the received information concerning the customer, wherein the second advising program replaces the first advising program and contains a different set of personal advising rules than the first advising program.

### BRIEF DESCRIPTION OF THE DRAWINGS

FIG. 1 is a block diagram of a hybrid automated investment selection system, according to an example embodiment.

FIG. 2 is a flow diagram of a method for selecting hybrid automated investment parameters for a customer, according to an example embodiment.

FIG. 3 is a flow diagram of a method for selecting investments for a customer based on hybrid automated investment parameters, according to an example embodiment.

FIG. 4 is a flow diagram of a method for updating the hybrid automated investment parameters selected for a customer to include a different percentage of non-automated financial advice, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting. For example, the embodiments of systems and methods discussed herein may be relevant to any of a variety of circumstances where using customer transaction history, life event data, activity data, or other information to update a level of automated investment selections by a financial institution may be useful.

Referring generally to the figures, systems and methods of selecting and implementing a personalized investment strategy for customers of a financial institution are disclosed. As referred to herein, the term “investment strategy” refers to a manner in which customer assets are invested by a financial institution. A particular investment strategy may identify investment parameters. Parameters, for example, may identify an allocation of the customer's assets between high risk investment instruments (e.g., stocks) and low risk investments instruments (e.g., bonds), or a total value of assets that the customer prefers to be invested. The systems and methods disclosed herein are configured to select parameters defining an investment strategy for a customer and implement the selected investment strategy by engaging in transactions (e.g., the purchasing or selling of investment instruments) on behalf of the customer.

According to the systems and methods disclosed herein, a financial institution computing system may be configured to select an investment strategy for a customer using any of a variety schemes (or “advising programs”) depending upon the circumstances of the particular customer. For one particular customer, the financial institution computing system may select an investment strategy in a purely automated manner, where the financial institution computing system assesses customer information with a set of automated advising rules that configure the financial institution computing system to take certain actions (e.g., conduct certain transactions) in response to certain triggers being detected (e.g., market trends, customer asset values, or customer life events).

If, however, the customer's financial situation changes (e.g., the customer acquires more financial assets, or a life situation develops such that the customer stands to benefit from personal input from a financial adviser), the financial institution computing system is configured to update the customer's advising program so that the customer receives more input from a financial adviser regarding the customer's investment strategy. In such situations, the financial institution computing system is configured to assess information pertaining to the customer using a set of personal advising rules that configure the financial institution computing system to implement an investment scheme based on input received from a financial adviser. Thus, the systems and methods disclosed herein select and implement investment strategies using varying levels of automation based on the need of the customer.

The embodiments and implementations of the systems and methods disclosed herein improve current automated financial advising systems by improving the quality and personalization of advice given to the customer responsive to determining the customer is in a financial or life situation that is not appropriate for purely automated advice. These systems, methods, and computer implementations improve the quality of advice given to the customer by leveraging data from a plurality of sources, such as customer transaction data, customer location data, customer-input data, and third party data, to determine when a high likelihood exists that the customer is in need of or otherwise qualifies for non-automated financial advice.

Referring to FIG. 1, a block diagram illustrating a hybrid automated investment selection system 100 is shown according to an example embodiment. The hybrid automated investment selection system 100 includes a customer computing device 110, financial institution computing system 120, merchants 140, and network 150. In some arrangements, the customer computing device 110, financial institution computing system 120, and POS terminal 142 associated with the merchant 140 all communicate with one another over the network 150, which may include one or more of the Internet, cellular network, Wi-Fi, Wi-Max, a proprietary banking network, or any other type of wired or wireless network.

The merchant 140 is an entity at which the customer may engage in a transaction. As part of the transaction, the customer may seek to pay for a good or service using a payment account associated with a financial institution. The merchant 140 may be located at a physical brick and mortar location, and may include a POS terminal 142 through which the customer makes a payment as part of a transaction at the merchant 140 using a payment account. The POS terminal 142 may include one or more processors and non-transitory storage mediums housing one or more logics that are configured to generate a transaction request containing payment account identifying information as well as other transaction information (e.g., merchant identifying information as well as transaction amount), and transmit that transaction request over the network 150 to the financial institution computing system 120 for authorization. In some arrangements, the customer may seek to conduct a transaction over the network 150 with the merchant 140, and the merchant 140 may use an e-commerce host (not shown) configured to transmit a transaction request to the financial institution computing system 120.

The customer computing device 110 is a computing device associated with a customer of the financial institution associated with the financial institution computing system 120. The customer computing device 110 includes one or more processors and non-transitory storage mediums housing one or more logics configured to enable the customer computing device 110 to exchange data over the network 150, execute software applications, access websites, generate graphical user interfaces, and perform similar operations. Examples of the customer computing device 110 include a personal computer such as a desktop or laptop computer, smartphones, tablets, wearable computing devices such as smartwatches and the like.

Customer computing device 110 includes a user network circuit 112 enabling the customer computing device 110 to exchange data over the network 150, a banking client 114, and a user I/O device 118. The user I/O device 118 includes hardware and associated logics configured to enable the customer computing device 110 to exchange information with a user, the financial institution computing system 120 and/or merchants 140, as will be described in greater detail below. An input device or component of the user I/O device 118 allows the user to provide information to the customer computing device 110, and may include, for example, a mechanical keyboard, a touchscreen, a microphone, a camera, a fingerprint scanner, any user input device engageable to the customer computing device 110 110 via a USB, serial cable, Ethernet cable, and so on. An output device or component of the user I/O device 118 allows the user to receive information from the user computing device 110, and may include, for example, a digital display, a speaker, illuminating icons, LEDs, and so on. The user I/O device 118 may be configured to include assemblies that serve both input and output functions, allowing the financial institution computing system 120 and merchant POS terminals 142 to exchange information with the customer computing device 110. Such assemblies include, for example, radio frequency transceivers (e.g., RF or NFC-based transceivers) and other short range wireless transceivers (e.g., Bluetooth™, laser-based data transmitters, etc.).

The banking client 114 includes program logic executable by the processor of the customer computing device 110 to enable the customer to interface with the financial institution computing system 120. As will be appreciated, the level of functionality that resides in the customer computing device 110 as opposed to the financial institution computing system 120 may vary depending on implementation. The banking client 114 may be a web browser configured to receive and display mobile web pages (e.g., web pages prompting the user to provide information to create an account, web pages displaying account information of other users, social media advertisements, and so on) or an application executed by the customer computing device 110.

In some arrangements, the banking client 114 includes advising logic 115, and account information 116. The account information 116 stores information pertaining to any interactions that the customer has had with the financial institution. This information may include account balance information, credit information, customer investment information, and the like. In some arrangements, the account information 116 also includes customer-input financial goal information, as will be described in greater detail below. In some arrangements, the account information 116 includes information pertaining to an investment strategy agreed to between the customer and the financial institution. The investment strategy information may inform the customer of the value of customer assets invested by the financial institution.

The advising logic 115 configures the customer computing device 110 (e.g., via the user I/O device 118) to display suggested implementations of an investment strategy to the customer. In some arrangements, the advising logic 115 includes a set of financial advising rules that configure the customer computing device 110 to assess customer information stored in the account information 116, and present various prompts instructing the customer to take certain actions with respect to an investment scheme (e.g., changing an asset allocation, changing an amount of assets investment, etc.) to the customer automatically without any customer initiation.

In some arrangements, the advising logic 115 is configured to present prompts to the customer instructing the customer to input investment preferences or other information. For example, prior to the customer agreeing to an investment strategy with the financial institution, the advising logic 115 may be configured to present the customer with an interface enabling the customer to indicate various preferences pertaining to, for example, financial goals (e.g., future purchases, expenses, and the like), risk tolerance, and a preferred investment horizon. As will be described below, the investment preferences of the customer may be used by the financial institution analysis circuit 124 in selecting an investment strategy for the customer,

In some arrangements, the advising logic 115 is further configured to present various prompts to the customer instructing the customer to input information concerning the customer's current life situation. For example, the advising logic 115 may be configured to periodically present the customer with an interface enabling the customer to provide answers to various queries. These queries may prompt the customer to provide information regarding finances, employment, marital status, health status, family, and the like. Any customer responses to these queries input via the user I/O device 118 may be transmitted to the financial institution computing system 120 by way of the network 150 for further processing by methods that will be described in greater detail below.

In some arrangements, the advising logic 115 is configured to retrieve information from other aspects of the customer computing device 110, or other devices communicatively coupled (e.g., via the user I/O device 118) to the customer computing device 110. In some arrangements, the customer computing device 110 further includes other hardware devices (not shown) capable of gathering other information concerning the customer. These other hardware devices may be implemented on, for example, the user I/O device 118, and may include a GPS device, or accelerometer, or external sensing device capable of tracking other forms of information (e.g. biometric information) regarding the customer. The banking client 114 may be configured to retrieve any information gathered by these hardware components and use this information in the methods to be described in greater detail below. Additionally, the banking client 114 may have various application programming interfaces (APIs) implemented thereon configuring the banking client 114 to retrieve information from other logics installed on the memory of the customer computing device 110. Using these APIs, the banking client 114 may gather information regarding customer interactions with third parties and the like to be used to implement the methods and processes described in greater detail below.

The financial institution computing system 120 is a computing system associated with a financial institution. The financial institution computing system 120 includes one or more processors and non-transitory storage mediums housing one or more logics configured to control the operation of the financial institution computing system 120. In some arrangements, the financial institution computing system 120 includes a financial institution network circuit 122, an analysis circuit 124, a financial institution account database 132, and a financial institution customer activity database 134. The financial institution network circuit 122 enables the financial institution computing system 120 to communicate with external computing devices, such as the customer computing device 110 and the merchant POS terminal 142 over the network 150.

The financial institution account database 132 is a storage device configured to retrievably store customer information relating to the various operations discussed herein, and may include non-transient data storage mediums (e.g., local disc or flash-based hard drives, local network servers, and the like) or remote data storage facilities (e.g., cloud servers). The customer account database 132 includes personal customer information (e.g., names, addresses, phone numbers, and so on), identification information (e.g., driver's license numbers, standard biometric data, and so on), and customer financial information (e.g., token information, account numbers, account balances, available credit, credit history, transaction histories, and so on).

In some arrangements, the customer account database 132 stores financial advising information for various customers. For example, the customer account database 132 may store customer responses to periodic information requests sent by the financial institution computing system 120 to the customer computing device 110 over the network 150. Additionally, once an investment strategy is set for a particular customer using methods to be described in greater detail below, the parameters (e.g., an asset allocation) of that relationship may also be stored in the customer account database 132.

The financial institution customer activity database 134 is a storage device configured to retrievably store other information related to the methods employed herein. The customer activity database 134 may include non-transient data storage mediums (e.g., local disc or flash-based hard drives, local network servers, and the like) or remote data storage facilities (e.g., cloud servers). The information stored in the customer activity database 134 may include, for example, customer transaction histories (e.g., transaction requests relayed to the financial institution computing system 120 from merchant POS terminals 142), information received from devices associated with the customer computing device 110 (e.g., GPS devices, sensing devices, etc.). As will be described in greater detail below, the financial institution computing system 120 may use the information stored in the customer activity database 134 to determine which financial advice to provide to the customer.

In some arrangements, the customer activity database 134 stores customer financial advising information. This customer financial advising information may include, for example, information pertaining to financial advice received by the customer. In some arrangements, the customer activity database 134 includes information that identifies the form (e.g., automated vs. personal) as well as the content of the advice. Additionally, the customer activity database may also include information pertaining to any actions taken by the customer as a result of having received the financial advice.

The analysis circuit 124 is configured to select an advising program for a customer and to implement an investment strategy for the customer in accordance with the selected advising program. In some arrangements, the analysis circuit 124 includes circumstance assessment logic 126, activity monitoring logic 128, and advising rules database 130. The advising rules database 130 stores a plurality of advising programs. Each advising program may include a plurality of advising rules. The advising rules may include program logic that configure the analysis circuit 124 to take certain actions with respect to a customer investment strategy (e.g., conduct transactions on behalf of the customer, reconfigure an asset allocation, request input from a financial adviser, etc.), responsive to certain triggers (e.g., market trends, receiving certain information from the customer, etc.).

In some arrangements, the advising programs stored in the advising rules database 130 include either automated advising rules, personal advising rules, or a combination of automated advising rules and personal advising rules. Automated advising rules may identify a first set of events and configure the analysis circuit 124 to take actions in relation to a customer investment strategy (e.g., conduct financial transactions on behalf of the customer, including buying or selling at least one security investment product, or suggesting that the customer do the same) responsive to one of the events in the first set of events being detected to have occurred in relation to the customer. For example, some automated advising rules may configure the analysis circuit to perform periodic rebalancing of an asset allocation associated with a customer investment strategy. To illustrate, the customer and the financial institution may have agreed on an asset allocation that includes 60% high-risk investment instruments (e.g., stocks) and 40% low-risk investment instruments (e.g., municipality bonds). In this instance, the analysis circuit 124 is configured to determine how long it has been since the asset allocation has been rebalanced, and if a predetermined threshold has been met (e.g., six months), rebalance the asset allocation (e.g., by selling stocks and using the proceeds to buy bonds to maintain the 60-40 relationship).

In some arrangements, the automated advising rules contain financial advising content to be transmitted to the customer computing device 110. In some arrangements, the financial advising content is associated with events (e.g., in the first set of events) that may be detected by the analysis circuit 124 (e.g., via the activity monitoring logic 128) to have occurred in relation to the customer. For example, the automated advising rules may be configured to provide suggestions to the customer responsive to certain changes in the account database 132. Some automated financial advising rules may contain content that provides the customer with certain suggestions responsive to customer account balances hitting certain threshold amounts, or responsive to certain account deposit or withdrawal patterns being detected in the information stored in the account database 132. For example, if a financial account of the customer drops below a threshold amount, one advising rule may generate a prompt suggesting that the customer purchase a certain form of investment instrument.

In some arrangements, the automated advising rules may also be configured to transmit suggestions for changing the customer's investment strategy to the customer computing device 110 responsive to the analysis circuit 124 determining that certain baseline circumstances are applicable to the customer. If, for example, information associated with the customer stored in the customer activity database 134 is indicative of a particular baseline circumstance, the automated advising rules may configure the analysis circuit 124 to generate suggestions relating to that circumstance. Baseline circumstances may include situations that have historically been associated with customers of the financial institution being in need of financial advice. These situations may include, for example, marriage, divorce, retirement planning, children, home purchasing, or the like. To illustrate, the analysis circuit 124 may detect that the customer is likely engaged or about to be married based on customer transaction information stored in the customer activity database 134 (e.g., the customer having engaged in transactions at wedding planning merchants), and the financial advising rules may be configured to transmit content to the customer computing device 110 notifying the customer about joint investment accounts.

In certain arrangements, the analysis circuit 124 is configured to transmit information requests to the customer computing device 110 over the network 150 via the financial institution network circuit 122. These information requests may include an interface presented to the customer on the customer computing device 110 (e.g., on the banking client 114). This interface may present the customer with several life events, and provide the customer with the ability to indicate whether any of the life events is applicable to them, and if so, when the life event occurred or is expected to occur. In some arrangements, the automated advising rules stored in the advising rules database 130 configure the analysis circuit 124 to provide suggestions to the customer responsive to the customer indicating that a particular event is applicable to them, similar to those discussed above. In some arrangements, the information requests transmitted to the customer also give the customer the ability to indicate any financial goals that they might have, and other automated advising rules may configure the analysis circuit 124 to generate customer suggestions responsive to certain financial goals being indicated by the customer. To illustrate, a particular customer having a long investment horizon may have initially agreed to a high-risk investment strategy with the financial institution. If this particular customer were to indicate in response to an information request sent to the customer computing device 110 that the customer plans to make a large purchase (e.g., buy a car) in the next few years, certain automated advising rules may configure the analysis circuit 124 to transmit a suggestion to the customer computing device 110 instructing the customer to allocate more assets to low-risk instruments having greater liquidity.

Personal advising rules may identify a second set of events and configure the analysis circuit 124 to receive input from a financial adviser prior to taking actions in relation to a customer investment strategy. Generally, the second set of events identified by the personal advising rules include events that generally make input from a financial adviser valuable to customers (e.g., situations where small changes in an investment strategy potentially have large implications for customers). In some arrangements, the personal advising rules configure the analysis circuit 124 to transmit prompts to the customer computing device 110 instructing the customer to contact a financial adviser. The personal advising rules may configure the analysis circuit 124 to transmit these prompts responsive to the detection of certain customer account activity being detected, such as a customer account balance stored in the financial institution account database 132 reaching a certain threshold amount. In some arrangements, personal advising rules will prompt the customer to contact a financial adviser when the financial institution computing system 120 (e.g., via the activity monitoring logic 128) detects that the customer is likely going through predesignated situation. Predesignated situations may be circumstances that have been identified by the financial institution as requiring a fact-intensive inquiry by a financial adviser in order to provide adequate financial advice.

In some arrangements, the various advising programs stored in the advising rules database 130 each include a different set of advising rules. For example, some advising programs may include only automated advising rules. Thus, when selecting and implementing a customer's investment strategy using automated advising programs, the analysis circuit 124 is configured to provide the customer with investment suggestions or conduct transactions on the customer's behalf in accordance with the automated advising rules without any input from a financial adviser. Other advising programs may include only personal advising rules. Thus, when implementing a customer's investment strategy using personal advising programs, the analysis circuit 124 is configured to provide a notification to a financial adviser (or other financial institution personnel), receive input from the financial advisor, and take actions with respect to the customer's investment strategy based on the received input from the financial adviser.

Other advising programs may be hybrid advising programs, and contain both personal and automated advising rules. Thus, when implementing a customer's investment strategy using a hybrid advising program, the analysis circuit 124 may be configured to take actions as dictated by the automated advising rules, or provide a notification to a financial adviser, depending on the circumstances. For example, a particular hybrid financial advising program may be configured to provide a customer with periodic input (e.g., quarterly, bi-annually, annually, etc.) from a financial adviser. Thus, the personal advising rules in the hybrid advising program may configure the analysis circuit 124 to determine how much time has passed since the input of a financial adviser has been received in the implementation of the customer's investment strategy, and seek input from a financial adviser when a predetermined timing threshold is met.

In some arrangements, the personal advising rules included in a hybrid financial advising program may configure the analysis circuit 124 to provide the customer with non-automated advice only responsive to certain events (e.g., in the second set of events) being detected to have occurred in relation to the customer. For example, the customer may be provided with input from financial institution personal (e.g., regarding the selling or buying of certain investment instruments) only responsive to account balances changing by more than a predetermined threshold. Automated actions identified by the automated advising rules included in the hybrid advising program may be taken responsive to account balance changes that are less than the predetermined threshold. Thus, in some examples, the analysis circuit 124 either implements an investment strategy in an automated manner or in a non-automated manner depending on the circumstances of the customer.

In some arrangements, each financial advising program stored in the advising rules database 130 is stored in association with a set of predetermined criteria. These predetermined criteria may identify sets of circumstances that have been historically associated with varying levels of financial advice. For example, the purely automated advising program discussed above may be the default advising program. Other financial advising programs, containing at least some personal advising rules, may be stored in relation to sets of qualifications that must be applicable to the customer in order for the customer to qualify for those advising programs. To provide an illustrative example, a particular hybrid advising program stored in the advising rules database 130 includes a set of advising rules that configure the analysis circuit 124 to implement a customer investment scheme in a mainly automated fashion (e.g., the analysis circuit 124 performs transactions on behalf of the customer as dictated by the automated advising rules in the hybrid advising program), but provides for input from a financial adviser responsive to an account balance of the customer changing by more than $50,000 in less than a six month period. The qualifications associated with this hybrid program may include: either (a) a minimum investment amount of $100,000; or (b) an estimated retirement for the customer within five years. Thus, in this particular example, in order to qualify for the hybrid investment program, the customer would need to either have an account balance of at least $100,000, or be within five years of a planned retirement.

In some arrangements, the predetermined criteria stored in association with the financial advising programs may include various wealth thresholds. In some arrangements, the higher the wealth threshold that a particular customer meets, the more customized input from a financial adviser that the customer receives in the implementation of their investment scheme. In some arrangements, the values that these wealth thresholds take with respect to a particular customer may vary depending on various other factors. For example, the wealth thresholds associated with a particular hybrid investment scheme may be lower for a customer who is married, holds assets in joint ownership with a spouse, and owns a home than for a single customer who does not own a home. This way, the financial institution computing system 120 generally gives more financial guidance to those customers who are in situations in which input from a financial adviser is most valuable.

In some arrangements, the financial advising rules stored in the advising rules database 130 may not be pre-arranged into financial advising programs, but individually stored in relation to predetermined criteria. Thus, to qualify for a particular financial advising rule, the customer may need to meet the predetermined criteria associated with that particular rule using methods similar to those discussed above.

The circumstance assessment logic 126 may be a set of instructions that configure the analysis circuit 124 to select an advising program for the customer. In some arrangements, the circumstance assessment logic 126 is configured to assess the totality of information regarding the customer to determine which of the predetermined criteria associated with the various advising programs stored in the advising rules database 130 are applicable to the customer. This information relating to the customer may include, for example, user financial account data stored in the account database 132, customer activity data stored in the financial institution customer activity database 134, and information received from the customer over the network 150 (e.g., customer information input into the banking client 114, information received from third parties, etc.). In some arrangements, if the analysis circuit 124 is unable to determine that any of the predetermined criteria are or are not applicable to a particular customer, the circumstance assessment logic 126 may be configured to transmit an information request over the network 150 to the customer computing device 110. In turn, the customer computing device 110, through the advising logic 115 of the banking client 114, may be configured to present the information request to the customer and receive any information input by the customer.

Once information pertaining to the customer is assessed to determine which of the predetermined criteria are applicable to the customer, the circumstance assessment logic 126 may further configure the analysis circuit 124 to select an advising program from the advising rules database 130 for the customer. In some arrangements, the circumstance assessment logic 126 configures the analysis circuit 124 to identify which financial advising programs or advising rules are associated with the predetermined criteria that are applicable to the customer.

In some arrangements, the analysis circuit 124 is configured to transmit any advising rules selected by the circumstance assessment logic 126 to the customer computing device 110 using the network 150. This way, the selected advising rules may be stored in the memory of the customer computing device 110 (e.g., in the advising logic 115 of the banking client 114) so that any automated advice sought by the customer may be generated directly in the customer computing device 110.

The activity monitoring logic 128 may be a set of instructions that configure the analysis circuit 124 to receive and monitor customer information. In some arrangements, the activity monitoring logic 128 configures the analysis circuit 124 to receive information from various sources regarding various customer actions and determine whether any of the financial advising rules contained within the selected financial advising program are triggered. Accordingly, in some arrangements, the financial institution computing system 120 receives information input by the customer into the customer computing device 110 via the user I/O device 118 over the network 150 via the financial institution network circuit 122. The activity monitoring logic 128 is configured to determine the nature of the information input by the customer (e.g. identify the response of the customer to a specific query posed by the financial institution computing system 120, identify any biographical information input by the customer, identify any asset information input by the customer, etc.), and compare that input to the set of events (e.g., the first set of events or the second set of events) identified by the advising program selected for the customer.

If the analysis circuit 124 determines that the received information concerning the customer is indicative of an event (e.g., in the first set of events or in the second set of events) identified by the advising rules selected for the customer, the activity monitoring logic 128 may further configure the analysis circuit 124 to take certain actions with respect to the customer's investment strategy. For example, if the account balance information stored in the account database 132 reaches a certain threshold that is identified by the financial advising rules, the activity monitoring logic 128 may further configure the analysis circuit 124 to identify the financial advising rule(s) that have been triggered by that event. If an automated advising rule has been triggered, the analysis circuit 124 may be configured to perform a transaction on the customer's behalf (e.g., purchase or sell an investment instrument such as a stock or a bond) that conforms with the triggered advising rule. If a personal advising rule is triggered, then the analysis circuit 124 may be configured to initiate a sequence to receive input from a financial adviser. This sequence may include, for example, transmitting the contact information of a financial adviser to the customer computing device 110, or transmitting an appointment signup interface to the customer computing device 110.

In some arrangements, the activity monitoring logic 128 also configures the analysis circuit 124 to assess customer transaction information (e.g., a customer transaction history stored in the customer activity database 134) to determine if any of the advising rules are triggered. For example, if the customer has engaged in repeated transactions at certain merchants, such a pattern may be indicative of an event (e.g., in the first set of events or in the second set of events) identified by the customer's advising program. For example, if the customer's transaction history reveals repeated transactions at a baby products store, this may be indicative that the customer is likely to have a child, which may be an event associated with a personal advising rule included in the customer's advising program. Accordingly, the activity monitoring logic 128 is configured to assess any customer transaction information stored in the customer activity database 134 to ascertain whether there are any such patterns that are indicative of events that are identified by the customer's advising program.

In some arrangements, the activity monitoring logic 128 is configured to assess other forms of information received over the network 150 from various sensing devices associated with the customer computing device 110. As discussed above, the customer computing device 110 may have various sensing devices, such as a GPS device, biometric sensors, or the like that gather information about the customer associated with the customer computing device 110. In some arrangements, the financial institution computing system 120 is configured to receive data from these components, store the data in a customer activity database 134, and determine whether the data is indicative of an event identified by the financial advising rules. For example, in some arrangements, the customer computing device 110 may include a GPS device that transmits customer location data to the financial institution computing system 120. The analysis circuit 124, through the activity monitoring logic 128, is configured to receive, store, and analyze this data to determine if a customer life event has occurred. For example, customer location data stored in the customer activity database 134 may indicate that the customer invariably spends working hours at a particular location. If the location of the customer during working hours suddenly changes for a prolonged period of time, for example, the analysis circuit 124 may determine that a significant customer life-event (e.g., change in employment) has likely occurred. The analysis circuit 124 identifies the life event from the received data, and compares the life event with the set of life events identified by the set of financial advising rules selected for the customer. If a match is found, the analysis circuit 124 is configured to identify the course of action mandated by the customer's advising program (e.g., make a change to the customer's investment strategy by purchasing an investment instrument, seek input from a financial adviser, etc.), and take the course of action.

In some arrangements, the analysis circuit 124 (via the activity monitoring logic 128) is configured to periodically assess the information stored in the customer account database 132 for changes in the customer's financial situation. For example, the analysis circuit 124 may be configured to determine when customer financial account balances change by greater than a predetermined threshold defined by the set of advising rules selected for the customer. In some arrangements, the analysis circuit 124 is further configured to assess third party information to determine an occurrence of the events identified by the advising rules. Third party information may comprise information pertaining to customers that the financial institution receives from entities providing services to customers. Such entities may include search engines, social networks, online merchants, and the like. In some arrangements, the analysis circuit 124 is configured to identify topics related to information that the customer has been seeking via third parties and to determine whether any of the information sought relates to any of the events identified by the financial advising rules. If a strong relationship is found between the customer third party content and one of the identified events, the analysis circuit 124 may be configured to treat that as if the event has occurred in relation to the customer, and take actions with respect to the customer's investment plan in conformance with the customer's advising rules.

In some arrangements, the activity monitoring logic 128 may be preconfigured with a set of trigger events. The trigger events may be events that, if detected in relation to a particular customer, are meant to initiate a process through which the set advising program selected for that customer is re-selected. These trigger events may be events that typically go hand-in-hand with a substantial increase or decrease in the value of personal advice. Examples of such events may include, for example, the purchasing or selling of a home, marriage or divorce, having a child, a child reaching a predetermined age, retirement, certain age thresholds, death of a family member, business closure, loss of employment, and the like. In some arrangements, the trigger events are pre-selected by the financial institution. In some arrangements, the trigger events are generated by the analysis circuit 124 through analyses of historical financial advising data. For example, the analysis circuit 124 may survey historical financial advising data and determine a set of events that led to an increase or decrease in customer-sought financial advice in the past. Irrespective of the method with which the set of triggering events is identified, if the financial institution computing system 120 detects (e.g. through monitoring customer activity with the activity monitoring logic 128) the occurrence of one of these events in relation to a particular customer, the analysis circuit 124, through the circumstance assessment logic 126, is configured to re-select an advising program (e.g. set of advising rules) for the customer.

Referring now to FIG. 2, a method 200 for selecting a set of advising rules for a customer is shown according to an example embodiment. In various arrangements, the method 200 may be performed by a processor and associate logics (e.g., the circumstance assessment logic 126, activity monitoring logic 128, and advising rules database 130 of the analysis circuit 124) stored in the memory of the financial institution computing system 120. In some arrangements, the method 200 is initiated responsive to the financial institution computing system 142 receiving an indication from the customer (e.g. input into the customer computing device 110 via the user I/O device 118) that the customer prefers to register for a financial advising program. In some arrangements, the method 200 may be performed automatically by the financial institution computing system 120 for any customer having account information stored in the account database 132.

At 202, customer information is received. In some arrangements, the received information includes information input by the customer into the customer computing device 110. The customer-input information may include, for example, customer financial goal information, customer risk-tolerance preferences, customer biographical information, and the like. The received information may also include information retrieved locally from the account database 132, information received from third parties, information captured by sensing devices associated with the customer computing device 110, and transaction information received from merchants 140.

At 204, the received information is assessed to determine which criteria associated with various advising programs are applicable to the received customer information. As discussed above, the analysis circuit 124 (e.g., by the circumstance assessment logic 126) may be configured to determine whether the received information is indicative of the customer meeting predetermined criteria stored in relation to the various advising programs in the advising rules database 130. For example, the analysis circuit 124 may assess any biographical information received (e.g., information input by the customer into the customer computing device, information stored in the account database 132, etc.) to determine whether the customer meets any biographical criteria (e.g., age thresholds, marriage, children, etc.). In some arrangements, the analysis circuit 124 may assess account balance information stored in the account database 132 to determine whether various wealth thresholds set by the advising programs are met. In some arrangements, the analysis circuit 124 is configured to assess information received from third parties, sensor information concerning the customer, or transaction information stored in the customer activity database 134 to determine whether any of the received information is indicative of any predetermined criteria being met.

At 206, it is determined if the customer qualifies for non-automated advice. As discussed above, financial advising programs including personal advising rules may be stored in the advising rules database 130 in association with various predetermined criteria. Accordingly in some arrangements, the analysis circuit 124 (e.g., by the circumstance assessment logic 126) is configured to determine if any of the criteria met by the customer (e.g., as determined at 204) are associated with a financial advising program stored in the advising rules database 130 that includes at least one personal advising rule.

At 208, an automated advising program is selected for the customer. In some arrangements, if the customer does not qualify for a personal advising program (e.g., does not meet any of the predetermined criteria stored in the advising rules database 130), an automated financial advising program is selected for the customer by the analysis circuit 124 (e.g., by the circumstance assessment logic 126). The automated financial advising program may include only the automated advising rules stored in the advising rules database 130 discussed above.

At 210, it is determined if the customer qualifies for a full adviser relationship providing advice on a personal basis. As discussed above, the advising rules database 130 may include a purely personal advising program that includes only personal advising rules. The purely personal advising program may be stored in the advising rules database 130 in association with a relatively strict set of predetermined criteria, such as a relatively high wealth threshold (e.g., $500,000), and/or a complex set of biographical criteria (e.g., marriage, home ownership, or the like) with respect to criteria of the non-full adviser relationship. Accordingly, in some arrangements, the analysis circuit 124 is configured to determine if the customer meets the criteria in the strict set of predetermined criteria stored in association with the purely personal advising program in the advising rules database 130. If the customer meets the criteria in the strict set of criteria, the purely personal advising program is selected for the customer at 214

If the customer does not qualify for the full adviser relationship, a hybrid advising program is selected for the customer at 212. In some arrangements, based on the criteria determined to be applicable to the customer at 204, the analysis circuit 124 selects an advising program containing both automated advising rules and personal advising rules for the customer. The particular personal advising rules included in the hybrid advising program may depend on the particular circumstances of the customer. In some arrangements, for example, the personal advising rules may configure the analysis circuit 124 to receive input from the financial institution at a predetermined frequency, with the frequency depending on a wealth threshold met by the customer (e.g., a customer investing $100,000 may receive quarterly input from a financial adviser, while a customer investing $500,000 may receive monthly input from a financial adviser).

At 216, customer advising program information is stored. In some arrangements, the stored advising program information is stored in association with the customer's account in the account database 132 so the stored advising program may be used to implement an investment strategy for the customer using the methods described in greater detail below. In some arrangements, the selected financial advising rules are also transmitted over the network 150 to the customer computing device 110 for storage in the customer computing device 110. In some arrangements, the stored advising program information also includes parameters of an overall investment strategy for the customer. For example, the parameters may include an investment amount for the customer and an asset allocation selected for the customer (e.g., selected by the customer or as selected by automated advising rules in the analysis circuit 124). The selected asset allocation may identify portions of the investment amount that are to be invested in various types of investment instruments (e.g., stocks, bonds, cash equivalents, etc.).

At 218, an investment strategy is implemented in accordance with the customer's advising program. In some arrangements, the analysis circuit 124 is configured to engage in transactions on behalf of the customer (e.g., buy a plurality of investment instruments) so that assets of the customer are invested in accordance with the advising program selected for the customer. In some arrangements, the analysis circuit 124 is configured to identify the parameters of the customer's investment strategy (e.g., an investment amount, and an investment allocation), receive input from a financial adviser (if required by the customer's advising program), purchase investment instruments for the customer, and update the customer's account information in the account database 132 to reflect the purchasing of the investment instruments. After the investment instruments are purchased, the analysis circuit 124 is configured to monitor customer information, using the methods described in greater detail below, and take actions with respect to the customer's investment strategy in accordance with the selected advising program for the customer.

Referring now to FIG. 3, a method 300 for implementing a customer investment program in accordance with an advising program is shown according to an example embodiment. In various arrangements, the method 300 may be performed by a processor and associated logics (e.g., the circumstance assessment logic 126, activity monitoring logic 128, and advising rules database 130 of the analysis circuit 124) stored in the memory of the financial institution computing system 120.

At 302, data concerning the customer is received. In some arrangements, the analysis circuit 124 via the activity monitoring circuit 128 is configured to receive information concerning the customer from a variety of sources. In some arrangements, the analysis circuit 124 is configured to periodically retrieve customer information stored in the account database 132, which may include, for example, customer account balance information, customer asset information and the like. Additionally, the analysis circuit 124 may also be configured to periodically retrieve information stored in the customer activity database 134, which may include, for example, a recent transaction history for the customer detailing recent transactions conducted by the customer, including the merchants 140 and transaction amounts. The information retrieved from the customer activity database 134 may also include data previously obtained by various sensing devices (e.g., GPS sensors, biometric sensors, and the like) associated with the customer configured to capture data pertaining to the customer's physiological state, location, and the like. Information stored in the customer activity database 134 or the account database 132 may also include information pertaining to the implementation of the customer's investment strategy by the financial institution, which may include, for example, the content of any advice received by the customer (e.g. suggestions the customer has received), the type (e.g., automated vs. non-automated) of the advice, and its timing.

At 304, it is determined if the customer's investment plan requires action. In some arrangements, the analysis circuit 124 (e.g., through the activity monitoring logic 128) is configured to determine if any of the data received at 302 triggers any of the advising rules (e.g., determine if any of the received data is indicative of the events identified by the advising rules) in the customer's advising program. For example, the information received at 302 may include information input by the customer into the customer computing device 110. The customer-input information may include an indication from the customer that a particular circumstance is applicable to the customer (e.g., marriage, first job, divorce, etc.). Accordingly, the analysis circuit 124 is configured to identify the particular circumstance and determine whether the advising rules included in the customer's advising program require action to be taken responsive to the indicated circumstance.

The analysis circuit 124 may also be configured to assess any information retrieved locally from account database 132 or customer activity database 134 to determine whether any advising rules in the customer's advising program are triggered. For example, the analysis circuit 124 may be configured to retrieve customer account balance information from the account database 132 and compare the customer account balance information with various thresholds identified by the advising rules in the customer's advising program to determine if any action needs to be taken regarding the customer's investment strategy.

In some arrangements, where the data received at 302 includes transaction data or data from sensing devices associated with the customer, the analysis circuit 124 may perform further operations to determine whether any advising rules have been triggered. For example, in the case of a transaction request received from a merchant 140, the analysis circuit 124 may be configured to determine various characteristics of the transaction (e.g., transaction amount, merchant identity, and the like), retrieve a customer transaction history from the account database 132, and identify any patterns in the customer's transaction history. For example, the analysis circuit 124 may determine that the customer has performed multiple transactions at various merchants in a particular category or types of items purchased from the merchants. Upon making such a determination, the analysis circuit 124 may determine if that merchant category is tied to any of the triggering events by, for example, accessing a lookup table. For example, multiple purchases at a furniture store may be indicative that the customer has recently purchased a home. Other transaction activity may be indicative of various other trigger events identified by the advising rules (e.g., marriage, children, or the like).

In some arrangements, the analysis circuit 124 may be configured to compare the customer's data (e.g., a customer transaction history, customer account balance data, and/or other activity data such as customer social media data, search engine history, biometric data, and the like) received at 302 with that of other customers who underwent life events. As discussed above, each advising rule in the customer's advising program may identify an action to take with respect to the customer's investment strategy (e.g., a transaction, reallocation, or the like) as well as a trigger. Each trigger may include a life event that is commonly associated with a substantial increase or decrease in a need for financial advice. The customer activity database 134 may include various activity datasets stored in association with various advising rule triggers. Such datasets may include sets of data describing various aspects of other customers that have gone through the associated triggering event. For example, the purchasing of a home may serve as a trigger. The activity database 134 may include a dataset describing the activity of various customers around the time leading up to when they purchased their homes. For example, the dataset may identify common merchants at which the customers made purchases and data describing the transactions (e.g., amounts) made at those merchants. Additionally, the dataset may describe various other aspects of the customers that underwent that life event (e.g., historical biometric data, age, time since gaining full time employment, education level, and the like). In some embodiments, the analysis circuit 124 is configured to compare the information regarding the customer received at 302 with the various datasets stored in association with the triggers of the customer's advising rules and determine whether there is sufficient correlation between the customer's data and the datasets. If so, the analysis circuit 124 may infer from the data that the customer is undergoing the correlated trigger, and proceed to step 306.

In some embodiments, rather than determine if any of the triggers identified by the customer's current set of advising rules have been detected, the analysis circuit 124 is configured to compare the customer data received at 302 with that of other customers who sought financial advice from the financial institution in the past. For example, the activity database 134 may store various profiles for various customers who sought financial advice. The profiles may include, for example, customer biographical data (e.g., age, marital status, income level, home ownership status, time spent living in a current residence, and the like), customer financial data (e.g., investment amounts, income levels, income level changes, account balances, and the like), and other customer data (e.g., social media data, biometric data, location data, and the like). Based on the customer data received at 302, the analysis circuit 124 may identify a profile that is correlated to the profile of the customer. For example, the analysis circuit 124 may identify the profile of another customer (or group of customers) having similar biographical data to that of the customer (e.g., living in the same location, having a similar income level). Further, the analysis circuit 124 may identify the action taken (e.g., the investment that resulted from the customer associated with the correlated profile seeking financial advice) with respect to the customer(s) associated with the similar profile(s). Further, after identifying the action, the analysis circuit 124 may notify the customer (or a financial adviser) of the action and seek to take the action with respect to the customer's investment strategy via any of the methods disclosed herein. Thus, the analysis circuit 124 may update the customer's advising program in real-time based on detected similarities to other, similarly situated customers who received financial advice from the financial institution. In this way, if the financial holdings of the customer differ from the financial holdings of a similarly situated other customer, the customer or an advisor of the customer can be provided an alert notifying them that the customer is not invested or making financial decisions in a same or similar way as other customers. For example, a notification may be provided to the customer indicating that the customer has $25,000 saved for retirement and an 80/20 ratio of stocks to bonds in their portfolio while other similarly situated customers (e.g., married couples in their 40s with two children and making $150,000 a year combined and living in the same geographic area) have on average $200,000 saved for retirement with 70/30 ratio of stocks to bonds in their investment portfolio. The notification may offer suggestions on how the customer can save more money for retirement or how to reallocate their investments to a more appropriate ratio of stocks and bonds. The notification may offer suggestions based on the transaction histories of the similarly situated customers (e.g., by indicating that most similarly situated customers max out their 401(k) account or other retirement accounts, or that the similarly situated customers typically take a certain tax deduction, such as an $7,000 mortgage interest tax deduction and that the customer could save more money if they likewise owned a house and took a similar tax deduction).

If none of the advising rules selected for the customer have been triggered by the received data, then no action is taken with respect to the customer's investment strategy, and the analysis circuit 124 may be configured to revert back to step 302 and continue to monitor any received data concerning the customer.

If the analysis circuit 124 determines that action is needed with respect to the customer's investment strategy, however, the analysis circuit 124 identifies the type of action needed at 306. In some arrangements, the customer's advising program pairs certain types of actions that the analysis circuit 124 is to take in response to certain customer events. For example, a particular advising program may include an automated advising rule that configures the analysis circuit 124 to sell stocks owned by the customer and purchase bonds for the customer in response to the value of the customer's stock holdings dropping by a predetermined amount (e.g., 5%). However, the advising program in this example may also include a personal advising rule that configures the analysis circuit 124 to notify a financial adviser responsive to the customer's stock holdings dropping by more than another predetermined amount (e.g., 10%). Accordingly, the analysis circuit 124 (e.g., by the activity monitoring logic 128) is configured to identify the type of action (e.g., an automated transaction versus seeking input from a financial adviser) by comparing the customer information with various triggers identified by the advising rules included in the customer's advising program.

If the analysis circuit 124 determines that the customer's advising program requires that an automated action be taken by the analysis circuit 124, then the analysis circuit 124 takes that action at 308. In some arrangements, the analysis circuit 124 identifies the automated advising rule triggered by the data received at 302, and performs the action identified by the triggered automated advising rule. Some automated advising rules may identify a transaction to be made on behalf of the customer (e.g., the purchasing of a certain value of stocks), or a shift in an asset allocation of the customer (e.g., an increase in bonds relative to stocks). Accordingly, the analysis circuit 124 may make any identified transactions on behalf of the customer. Some automated advising rules may identify content to be delivered to the customer that identifies the action to be taken with respect to the customer's investment strategy. Accordingly, in some arrangements, the analysis circuit may be configured to transmit investing suggestions to the customer computing device 110 over the network 150, and receive any customer responses (e.g., an authorization to perform the designated action) to the transmitted suggestions.

If the analysis circuit 124 determines that the customer's advising program requires input from a financial adviser then the analysis circuit 124 notifies a financial adviser that personal input is required at 310. In some arrangements, the analysis circuit 124 is configured to transmit a notification containing content identifying the customer and including customer investment strategy information (e.g., customer asset information, as well as the circumstances that require personal input) to a computing device associated with a financial adviser or other financial institution personnel. The content transmitted to the adviser may also include an interface that gives the financial adviser the ability to input parameters that identify an action (e.g., transaction) to be taken with respect to the customer's investment strategy. In some arrangements, responsive to input from the financial adviser, the analysis circuit 124 is configured to take an action that conforms to parameters input by the financial adviser.

In some arrangements, the analysis circuit 124 is configured to transmit content to the customer computing device 110 over the network 150 via the network circuit 122 giving the customer the ability to contact a financial adviser or to set up an appointment. The content may also identify the circumstance (e.g., a change in an account balance, an elapsed time period since the customer last received input from an adviser, etc.) that precipitated the need for personal input. In some arrangements, the content transmitted to the customer computing device 110 identifies at least one financial adviser, and includes at least one of a name, phone number, office location, and the like.

Referring now to FIG. 4, a method 400 of updating a customer's financial advising program is shown according to an example embodiment. In various arrangements, the method 400 may be performed by a processor and associated logics (e.g., the circumstance assessment logic 126, activity monitoring logic 128, and advising rules database 130 of the analysis circuit 124) stored in the memory of the financial institution computing system 120. In some arrangements, the method 400 is performed simultaneously with the method 300 discussed above in relation to FIG. 3. In some arrangements, the method 400 is performed periodically by the financial institution computing system 120.

At 402, data concerning the customer is received. In some arrangements, the analysis circuit 124 (e.g., via the activity monitoring logic 128) is configured to receive information concerning the customer from a variety of sources, and package the received information with information concerning the customer stored in the account database 132 and the customer activity database 134 to form a set of updated customer information. The received information may be in a similar form as that discussed in relation to FIG. 3.

At 404, it is determined whether any of the customer data received at 404 constitutes a triggering event. As discussed above, in some arrangements, the activity monitoring logic 128 of the analysis circuit 124 may be pre-configured with a set of triggering events that tend to lead to a substantial increase or decrease in the customer's need for financial advice. Accordingly, the analysis circuit 124 (e.g., via the activity monitoring logic 128) is configured to determine whether any of the data concerning the customer received at 402 is indicative of a triggering event. This is done in ways similar to determining whether the customer is in need of any financial advice discussed in relation to FIG. 3.

At 406, if the analysis circuit 124 determines that a triggering event has occurred, the analysis circuit 124 assesses the information received at 302 to determine if the customer qualifies for a new advising program. In some arrangements, the analysis circuit 124 (e.g., via the circumstance assessment logic 126) is configured to determine which of the predetermined criteria stored in the financial rules database 130 are applicable to the updated information concerning the customer. If the set of criteria applicable to the updated customer information are different than the criteria that was previously applicable to the customer, then the customer may qualify for a different financial advising program. If the updated customer information does not meet different criteria, the financial analysis circuit 124 may be configured to revert back to step 402 to continue to monitor customer information.

At 408, a new advising program is selected for the customer. In the event that the updated customer information meets different criteria, the analysis circuit 124 may be configured to select a new advising program from the advising rules database 130 for the customer and store the new advising program in the account database 132 in association with the customer's account using similar methodologies to those discussed above in relation to the method 200 shown in FIG. 2. In some situations, the customer's new advising program may provide the customer with a different level of non-automated financial advice than the customer's previous advising program. If, for example, the updated customer information received at 402 meets criteria associated with advising programs that include more personal advising rules than the customer's previous advising program (e.g., the customer's wealth increased), the customer's new advising program may provide the customer with more personal input from a financial adviser. Put differently, under the new advising program, the customer will tend to receive input from a personal financial adviser more frequently.

In other situations, the customer's new advising program may provide the customer with less non-automated financial advice than the customer's old program. For example, the updated customer information received at 302 may indicate that the customer needs less input from a financial adviser than customer used to (e.g., the customer has reduced the amount of assets invested, or accomplished a financial goal). Accordingly, at 408, the analysis circuit 124 may determine that the updated customer information received at 402 only meets criteria associated with an advising program that includes less personal advising rules than the customer's previous advising program. Under the new advising program, then, the analysis circuit 124 may be configured to take actions with respect to the customer's investment strategy in a more automated fashion than under the customer's previous advising program.

At 410, the financial institution computing system 120 monitors customer information to determine if actions are required by the customer's updated advising program. In various arrangements, the analysis circuit 124 (e.g., via the activity monitoring logic 128) receives data concerning the customer in similar ways to those discussed above in relation to the method 300 shown in FIG. 3. Thus, the qualities of the financial advice provided to the customer are updated as the customer's financial situation changes.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

As used herein, the phrase “stand to benefit from personal financial advice” generally refers to situations where the value added by a financial adviser (e.g., the increase in returns that a non-automated implementation provides over an automated implementation) offsets the increased costs (e.g., fees) associated with the provision of personal financial advice. As used herein, the phrase “stand to benefit from personal financial advice” also encompasses situations where the potential financial losses (e.g., caused by a misallocation of assets in implementing an investment scheme) for a customer are great enough to justify the increased costs associated with the provision of personal financial advice. The phrase also includes situations in which there is a high likelihood that the investment scheme suggested by a financial adviser will differ from that which is suggested by the automated advising rules by more than a predetermined threshold.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In some embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system comprising:
an advising rules database configured to store a plurality of advising programs, wherein each advising program includes at least one automated advising rule and/or at least one personal advising rule, wherein each automated advising rule is associated with at least one event of a first event type associated with at least one investment action, wherein each personal advising rule is associated with at least one event of a second event type and is associated with receiving input from an advisor of a financial institution;
an account database configured to store customer information concerning a plurality of financial accounts at the financial institution;
a network interface configured to communicate data with at least one of a customer computing device associated with a customer, a plurality of merchant computing devices, and a plurality of third party computing devices over a network; and
an analysis circuit communicatively coupled to the advising rules database, the account database, and the network interface, the analysis circuit configured to:
select a first advising program for the customer from the advising rules database;
receive customer transaction data, over the network via the network interface, from at least one of the following: the customer computing device, one of the plurality of merchant computing devices, and one of the plurality of third party computing devices;
determine a pattern based on the customer transaction data;
determine the customer has experienced a life event based on the pattern, wherein the life event is either a first type of life event or a second type of life event;
provide, by the customer computing device, a first prompt based on the life event being the first type of life event, the first prompt requesting information relating to a financial goal of the customer and including a first interface enabling the customer to input information in response to the first prompt;
generate, in response to receiving the information relating to the financial goal of the customer, a second prompt based on the financial goal of the customer and displaying a suggested alteration to the first advising program and a second interface enabling the customer to input information in response to the second prompt, the second prompt requesting the customer's response to the suggested alteration;
provide by the customer computing device, the second prompt and the second interface to the customer;
select a second advising program from the advising rules database for the customer in response to receiving the customer's response, wherein the second advising program contains a different set of personal advising rules than the first advising program;
conduct an automated transaction on behalf of the customer based on the selected second advising program; and
update the customer information in the account database to reflect that the automated transaction has occurred.

2. The system of claim 1, wherein the analysis circuit is further configured to:
receive information, over the network via the network interface, concerning the customer from at least one of the following: the customer computing device, one of the plurality of merchant computing devices, and one of the plurality of third party computing devices; and
identify predetermined criteria stored in the advising rules database applicable to the customer based on the received information concerning the customer, wherein the selection of the second advising program is based on the identified predetermined criteria.

3. The system of claim 2, wherein the predetermined criteria include at least one financial asset value threshold.

4. The system of claim 3, wherein the predetermined criteria also include a set of baseline financial situations relating to at least one of the following: a customer employment status, a customer marital status, a customer family status, and a customer education level.

5. The system of claim 4, wherein the second advising program includes only automated advising rules based on none of the predetermined criteria being applicable to the customer.

6. The system of claim 1, wherein the analysis circuit is further configured to:
receive information, over the network via the network interface, concerning the customer from at least one of the following: the customer computing device, one of the plurality of merchant computing devices, and one of the plurality of third party computing devices;
determine if the received information concerning the customer is indicative of an event of the first event type identified by an automated advising rule included in the second advising program; and
perform, in response to the received information being indicative of the event of the first event type, at least one investment action associated with the automated advising rule in the advising rules database.

7. The system of claim 6, wherein the at least one investment action includes the buying or selling of an investment instrument on behalf of the customer.

8. The system of claim 6, wherein the at least one investment action includes transmitting, over the network via the network interface, an investment suggestion to the customer computing device.

9. The system of claim 1, wherein the analysis circuit is further configured to:
receive information, over the network via the network interface, concerning the customer from at least one of the following: the customer computing device, one of the plurality of merchant computing devices, and one of the plurality of third party computing devices;
determine if the received information concerning the customer is indicative of an event of the second event type identified by a personal advising rule included in the second advising program; and
initiate, in response to the received information concerning the customer being indicative of an event of the second event type, a sequence to receive input from the advisor of the financial institution regarding an investment strategy of the customer.

10. The system of claim 9, wherein the analysis circuit is further configured to:
receive input from the advisor of the financial institution; and
perform at least one investment action with respect to the investment strategy of the customer based on the received input.

11. A method comprising:
selecting, by a financial institution computing system, a first advising program for a customer, the first advising program selected from a plurality of advising programs stored in an advising rules database associated with the financial institution computing system, wherein each advising program in the plurality of advising programs includes at least one automated advising rule and/or at least one personal advising rule, wherein each automated advising rule identifies at least one event of a first event type and is associated with at least one investment action, wherein each personal advising rule identifies at least one event of a second event type and is associated with receiving input from an advisor of a financial institution associated with the financial institution computing system;
receiving, by the financial institution computing system, customer transaction data from at least one of the following: a customer computing device associated with the customer, at least one merchant computing device, and at least one third party computing device;
determining a pattern based on the customer transaction data;
determining the customer has experienced a life event based on the pattern, wherein the life event is either a first type of life event or a second type of life event;
providing, by the customer computing device, a first prompt based on the life event being the first type of life event, the first prompt requesting information relating to a financial goal of the customer and including a first interface enabling the customer to input information in response to the first prompt;
generating, in response to receiving the information relating to the financial goal of the customer, a second prompt based on the financial goal of the customer and displaying a suggested alteration to the first advising program and a second interface enabling the customer to input information in response to the second prompt, the second prompt requesting the customer's response to the suggested alteration;
providing, by the customer computing device, the second prompt and the second interface to the customer;
selecting, by the financial institution computing system, a second advising program from the advising rules database for the customer in response to receiving the customer's response, wherein the second advising program contains a different set of personal advising rules than the first advising program;
conduct an automated transaction on behalf of the customer based on the selected second advising program; and
update customer information in an account database to reflect that the automated transaction has occurred.

12. The method of claim 11, wherein the advising rules database also includes predetermined criteria associated with various advising programs in the plurality of advising programs, wherein the method further comprises:
receiving, by the financial institution computing system, information concerning the customer from at least one of the following: the customer computing device associated with the customer, the at least one merchant computing device, and the at least one third party computing device; and
identifying, by the financial institution computing system, predetermined criteria applicable to the customer based on the received information concerning the customer, wherein the selection of the second advising program is based on the identified predetermined criteria.

13. The method of claim 12, wherein the predetermined criteria include at least one financial asset value threshold.

14. The method of claim 13, wherein the predetermined criteria also include a set of baseline financial situations relating to one of the following: a customer employment status, a customer marital status, a customer family status, and a customer education level.

15. The method of claim 14, wherein the second advising program includes only automated advising rules based on none of the predetermined criteria being applicable to the customer.

16. The method of claim 11, further comprising:
receiving, by the financial institution computing system, information concerning the customer from at least one of the following: the customer computing device associated with the customer, the at least one merchant computing device, and the at least one third party computing device;
determining, by the financial institution computing system, if the received information concerning the customer is indicative of an event of the first event type identified by an automated advising rule included in the second advising program; and
performing, by the financial institution computing system, in response to the received information being indicative of the event of the first event type, at least one investment action associated with the automated advising rule in the advising rules database.

17. The method of claim 16, wherein the at least one investment action includes the buying or selling of an investment instrument on behalf of the customer.

18. The method of claim 11, further comprising:
receiving, by the financial institution computing system, information concerning the customer from at least one of the following: the customer computing device associated with the customer, the at least one merchant computing device, and the at least one third party computing device;
determining, by the financial institution computing system, if the received information concerning the customer is indicative of an event of the second event type identified by a personal advising rule included in the second advising program;
initiating, by the financial institution computing system, in response to the received information concerning the customer being indicative of an event of the second event type, a sequence to receive input from the advisor of the financial institution regarding an investment strategy of the customer;
receiving, by the financial institution computing system, input from the advisor of the financial institution; and
performing, by the financial institution computing system, at least one investment action with respect to the investment strategy of the customer based on the received input.

19. A non-transitory computer readable media having computer-executable instructions embodied therein that, when executed by an analysis circuit of a financial institution computing system, causes the financial institution computing system to perform operations to implement an investment strategy of a customer, the operations comprising:
selecting a first advising program for the customer, the first advising program selected from a plurality of advising programs stored in an advising rules database associated with the financial institution computing system, wherein each advising program in the plurality of advising programs includes at least one automated advising rule and/or at least one personal advising rule, wherein each automated advising rule identifies at least one event of a first event type associated with at least one investment action, wherein each personal advising rule identifies at least one event of a second event type and associated with receiving input from a human advisor of a financial institution associated with the financial institution computing system;
receiving customer transaction data from at least one of the following: a customer computing device associated with the customer, at least one merchant computing device, and at least one third party computing device;
determining a pattern based on the customer transaction data;
determining the customer has experienced a life event based on the pattern, wherein the life event is either a first type of life event or a second type of life event;
providing, by the customer computing device, a first prompt based on the life event being the first type of life event, the first prompt requesting information relating to a financial goal of the customer and including a first interface enabling the customer to input information in response to the first prompt;
generating, in response to receiving the information relating to the financial goal of the customer, a second prompt based on the financial goal of the customer and displaying a suggested alteration to the first advising program and a second interface enabling the customer to input information in response to the second prompt, the second prompt requesting the customer's response to the suggested alteration;
providing, by the customer computing device, the second prompt and the second interface to the customer;
selecting a second advising program from the advising rules database for the customer in response to receiving the customer's response, wherein the second advising program replaces the first advising program and contains a different set of personal advising rules than the first advising program;
conduct an automated transaction on behalf of the customer based on the selected second advising program; and
update customer information in an account database to reflect that the automated transaction has occurred.

20. The non-transitory computer readable media of claim 19, wherein the advising rules database also includes predetermined criteria associated with various advising programs in the plurality of advising programs, wherein the operations further comprise:
receiving information concerning the customer from at least one of the following: the customer computing device associated with the customer, the at least one merchant computing device, and the at least one third party computing device;
identifying predetermined criteria applicable to the customer based on the received information concerning the customer, wherein the selection of the second advising program is based on the identified predetermined criteria, and wherein the predetermined criteria include at least one financial asset value threshold.

21. The system of claim 1, wherein a plurality of prompts are periodically provided to present the customer with an interface enabling the customer to input information in response based on a current life situation of the customer.
